(19) United States
(12) Patent Application Publication
(10) Pub. No.: US 2019/0267184 A1
(43) Pub. Date: Aug. 29, 2019

(54) REACTOR AND METHOD FOR PRODUCING REACTOR

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka (JP)

(72) Inventors: Kouhei YOSHIKAWA, Yokkaichi, Mie (JP); Kazuhiro INABA, Yokkaichi, Mie (JP)

(73) Assignees: AutoNetworks Technologies, Ltd., Yokkaichi, Mie (JP); Sumitomo Electric Industries, Ltd., Osaka (JP); Sumitomo Wiring Systems, Ltd., Yokkaichi, Mie (JP)

(21) Appl. No.: 16/318,833

(22) PCT Filed: Jul. 7, 2017
(86) PCT No.: PCT/JP2017/024972

§ 371 Date: Jan. 18, 2019

(30) Foreign Application Priority Data
Jul. 22, 2016 (JP) 2016-144591

(51) Int. Cl. H01F 27/32; H01F 27/30; H01F 27/24; H01F 1/20

(52) U.S. Cl. CPC H01F 27/327; H01F 1/20; H01F 27/24; H01F 27/306

(57) ABSTRACT

A reactor includes a coil having a pair of wound portions arranged side-by-side, a magnetic core having inner core portions and outer core portions, and a case that houses an assembly of the coil and the magnetic core. The case includes a bottom plate portion and a side wall portion that opposes outer peripheral surfaces of the outer core portions. The magnetic core is composed of a composite material and is joined to the bottom plate portion and the side wall portion. When a direction in which the wound portions are arranged in a side-by-side arrangement direction, the side wall portion includes a cut-out portion that exposes at least one of an external side surface of one of the wound portions and an external side surface of the other of the wound portions in the side-by-side arrangement direction to the outside of the case.

### CROSS-REFERENCE TO RELATED APPLICATIONS

This application is the U.S. national stage of PCT/JP2017/024972 filed Jul. 7, 2017, which claims priority of Japanese Patent Application No. JP 2016-144591 filed Jul. 22, 2016.

### TECHNICAL FIELD

The present disclosure relates to a reactor and a method for producing the reactor.

### BACKGROUND

JP 2013-128084A discloses a reactor that includes a coil having a pair of wound portions arranged side-by-side and a magnetic core forming a closed magnetic circuit and is used as a component of a converter of a hybrid automobile, for example. The magnetic core can be divided into inner core portions that are disposed inside the wound portions and outer core portions that are disposed outside the wound portions. An assembly of the above-described coil and magnetic core is housed in a case.

With respect to a reactor that includes a case, the use of a magnetic core composed of a composite material containing a soft magnetic powder and a resin has been studied. In this case, the magnetic core composed of the composite material can be physically protected by the case that houses the assembly. However, since the entire periphery of the assembly is enclosed by the case, heat dissipation from the assembly to the outside may be inhibited.

To address this issue, an object of the present disclosure is to provide a reactor that includes a case for protecting a magnetic core and has excellent heat dissipation properties. Also, an object of the present disclosure is to provide a method for producing a reactor that makes it possible to produce a reactor that includes a case for protecting a magnetic core and has excellent heat dissipation properties.

### SUMMARY

A reactor of the present disclosure includes a coil having a pair of wound portions that are arranged side-by-side. A magnetic core having inner core portions are disposed inside the wound portions and outer core portions and are exposed from the wound portions. A case houses an assembly of the coil and the magnetic core, wherein the case includes a bottom plate portion on which the assembly is mounted and a side wall portion having portions that oppose outer peripheral surfaces of the outer core portions. The magnetic core is composed of a composite material containing a soft magnetic powder and a resin, and is joined to an upper surface of the bottom plate portion and an inner peripheral surface of the side wall portion, at positions of the outer core portions, and when a direction in which the wound portions are arranged side-by-side is referred to as a side-by-side arrangement direction, the side wall portion includes a cut-out portion that exposes at least one of an external side surface of one of the wound portions in the side-by-side arrangement direction and an external side surface of the other of the wound portions in the side-by-side arrangement direction to the outside of the case.

A method for producing a reactor of the present disclosure is a method for producing a reactor in which an assembly of a coil and a magnetic core is housed in a case, the coil having a pair of wound portions that are arranged side-by-side, and the magnetic core having inner core portions that are disposed inside the wound portions and outer core portions that are exposed from the wound portions. The method includes a case preparing step of preparing a case serving as the case that houses the coil and including a side wall portion having a cut-out portion that, when a direction in which the wound portions are arranged side-by-side is referred to as a side-by-side arrangement direction, exposes at least one of an external side surface of one of the wound portions in the side-by-side arrangement direction and an external side surface of the other of the wound portions in the side-by-side arrangement direction. A disposition step of housing the coil inside the case and a filling step of filling a composite material containing a soft magnetic powder and a resin into spaces between end surfaces of the wound portions of the coil and the case, thereby forming the magnetic core composed of the composite material.

### BRIEF DESCRIPTION OF DRAWINGS

FIG. 1 is a perspective view of a reactor according to Embodiment 1.

FIG. 2 is a perspective view of the reactor according to Embodiment 1 when viewed from the opposite side to that of FIG. 1.

FIG. 3 is a partially exploded perspective view of the reactor according to Embodiment 1.

FIG. 4 is a perspective view of a reactor according to Embodiment 2.

FIG. 5 is a perspective view of the reactor according to Embodiment 2 when viewed from the opposite side to that of FIG. 4.

FIG. 6 is a partially exploded perspective view of the reactor according to Embodiment 2.

FIG. 7 is a schematic perspective view of a case included in a reactor according to Embodiment 3.

### DETAILED DESCRIPTION OF PREFERRED EMBODIMENTS

The reactor according to the present disclosure includes a case for protecting a magnetic core and has excellent heat dissipation properties.

The method for producing a reactor according to the present disclosure makes it possible to produce the reactor of the present disclosure that includes a case for protecting a magnetic core and has excellent heat dissipation properties.

First, aspects of the present disclosure will be listed and described.

A reactor according to an embodiment is a reactor includes a coil having a pair of wound portions that are arranged side-by-side. A magnetic core having inner core portions are disposed inside the wound portions and outer core portions that are exposed from the wound portions. A case that houses an assembly of the coil and the magnetic core, wherein the case includes a bottom plate portion on which the assembly is mounted and a side wall portion having portions that oppose outer peripheral surfaces of the outer core portions. The magnetic core is composed of a composite material containing a soft magnetic powder and a resin, and is joined to an upper surface of the bottom plate portion and an inner peripheral surface of the side wall portion, at positions of the outer core portions. When a direction in which the wound portions are arranged side-by-side is referred to as a side-by-side arrangement direction, the side wall portion includes a cut-out portion that exposes at least one of an external side surface of one of the wound portions in the side-by-side arrangement direction and an external side surface of the other of the wound portions in the side-by-side arrangement direction to the outside of the case.

With the reactor according to the embodiment, since the side wall portion, which opposes the outer core portions of the magnetic core, is provided, the outer core portions composed of the composite material can be physically protected. Also, since at least one of the external side surface of one of the wound portions of the coil and the external side surface of the other of the wound portions is exposed from the case, heat is more likely to dissipate from the coil to the outside of the case, and thus, the reactor according to the embodiment has excellent heat dissipation properties. The configuration in which the external side surface of at least one of the wound portions is exposed from the case also has the advantage in that less of the constituent materials of the case can be used.

Moreover, with the reactor according to the embodiment, since the magnetic core is joined to the bottom plate portion and the side wall portion, heat is likely to be transmitted from the magnetic core to the case, and heat is then likely to dissipate to the outside of the case via the case. Thus, the reactor according to the embodiment has excellent heat dissipation properties.

In the reactor according to the embodiment, it is also possible that the side wall portion includes a pair of core opposing portions that oppose the outer peripheral surfaces of the outer core portions. One of said cut-out portions that exposes the external side surface of one of the wound portions to the outside of the case and another one of said cut-out portions that exposes the external side surface of the other of the wound portions to the outside of the case.

The heat dissipation properties of the reactor can be improved by adopting this configuration in which the external side surfaces of both wound portions are exposed from the case.

In the reactor according to the embodiment, it is also possible that the side wall portion includes. A pair of core opposing portions that oppose the outer peripheral surfaces of the outer core portions. A coil opposing portion connects the pair of core opposing portions to each other and opposes the external side surface of one of the wound portions or the external side surface of the other of the wound portions. The cut-out portion that exposes the external side surface of the wound portion on the opposite side to the wound portion that is covered by the coil opposing portion to the outside of the case. The reactor further includes a heat dissipation material that is disposed between the coil opposing portion and the wound portion.

With this configuration, the flexibility of installation of the reactor can be increased more than the configuration in which the external side surfaces of both wound portions are exposed, while improving the heat dissipation properties of the reactor. The reason for this is that, with the configuration in which the side wall portion of the case includes the coil opposing portion, not only the bottom plate portion and the core opposing portions but also the coil opposing portion can be used as an attachment portion that can be attached to an object in which the reactor is installed.

Moreover, the dissipation of heat via the coil opposing portion can be improved by disposing the heat dissipation material between the coil opposing portion and a side surface of the coil. In particular, in the case where the coil opposing portion is used as an attachment portion that can be attached to an object in which the reactor is installed, the dissipation of heat to the object via the coil opposing portion can be promoted by the above-described heat dissipation material. For example, heat dissipation grease, which has excellent thermal conductivity, can be used as the heat dissipation material.

In the reactor according to the embodiment, it is also possible that the reactor further includes a pair of end surface connecting members that are disposed between end surfaces of the wound portions and the outer core portions, wherein the inner peripheral surface of the side wall portion abuts against at least a portion of external side surfaces of the end surface connecting members that oppose each other in the side-by-side arrangement direction.

Insulation between the outer core portions and the wound portions can be reliably ensured by providing the end surface connecting members. Also, since at least a portion of the external side surfaces of the end surface connecting members abuts against the inner peripheral surface of the side wall portion of the case, when filling the composite material into the case during the production of the reactor, leakage of the composite material from gaps between the side wall portion and the end surface connecting members can be suppressed.

In the reactor according to the embodiment in which the pair of end surface connecting members are provided, it is also possible that each of the end surface connecting members includes protruding portions that protrude outward in the side-by-side arrangement direction, the protruding portions being located at positions near the wound portions of the external side surfaces of the end surface connecting members that oppose each other in the side-by-side arrangement direction of the wound portions, and when a side on which end portions of a wire that forms the wound portions are disposed is referred to as a wire end portion side, and a side on which a connecting portion of the wire that connects the pair of wound portions to each other is disposed is referred to as a connecting portion side, the protruding portions of the end surface connecting member on the connecting portion side have a tapered shape that slopes to the wire end portion side toward leading ends of the protruding portions in the protruding directions.

The protruding portions included in the end surface connecting member on the connecting portion side are portions that are pressed against when filling the composite material into the case during the production of the reactor. As a result of the end surface connecting member on the connecting portion side being pressed via the protruding portions toward the wire end portion, the end surface connecting member on the wire end portion side abuts against and is thus stopped by the case, and the end portions of the wire of the coil are precisely disposed at predetermined positions of the case. The end portions of the wire are each connected to terminals of external devices, and therefore, if the end portions of the wire are disposed at predetermined positions of the case, it is easy to connect the end portions of the wire to the terminals of the external devices. On the other hand, the protruding portions of the end surface connecting member on the wire end portion side are portions that abut against and are stopped by the case.

In the reactor according to the embodiment, it is also possible that the coil includes a coil molded portion composed of an insulating resin, and the coil molded portion includes: turn coating portions that integrate the turns of the wound portions; and end surface coating portions that are disposed between the end surfaces of the wound portions and the outer core portions.

Since the turns of the coil are integrated by the turn coating portions of the coil molded portion, when filling the inside of the wound portions with the composite material during the production of the reactor, leakage of the composite material from between the turns of the wound portions can be suppressed. Also, the end surface coating portions of the coil molded portion can ensure insulation between the end surfaces of the wound portions and the outer core portions. Furthermore, with the configuration in which the inner peripheral surface of the side wall portion abuts against at least a portion of the external side surfaces of the end surface coating portions of the coil molded portion that oppose each other in the side-by-side arrangement direction, when filling the composite material into the case during the production of the reactor, leakage of the composite material from the gaps between the end surface coating portions and the side wall portion can be suppressed.

In the reactor according to the embodiment, it is also possible that the side wall portion includes a pair of core opposing portions that oppose outer peripheral surfaces of the outer core portions, each of the core opposing portions includes a detachment preventing recess that is formed by a portion near the bottom plate portion of an inner peripheral surface of the core opposing portion being recessed in a direction away from a corresponding one of the outer core portions, and a portion of the outer core portion enters the detachment preventing recess.

Since a portion of the outer core portions enters the detachment preventing recess and engages with the detachment preventing recess, detachment of the assembly from the case can be effectively suppressed.

In the reactor according to the embodiment, it is also possible that the reactor further includes gap portions in the outer core portions.

As will be described later in the description of the method for producing a reactor, the reactor of the embodiment is produced by disposing the coil inside the case and then filling the composite material into the inside of the case. Therefore, it is difficult to provide gap portions at positions of the inner core portions, which are disposed inside the wound portions of the coil. The reason for this is that, even if members serving as gap portions are disposed inside the wound portions beforehand during filling of the composite material, it is difficult to fix the members at the predetermined positions because the wound portions are an obstruction, and the positions of the members are changed by the filling pressure of the composite material. In contrast, if gap portions are disposed at positions outside the coil, the problem of it being difficult to fix the members serving as the gap portions due to the coil being an obstruction is eliminated, and thus, predetermined gap portions can be formed in the magnetic core. Magnetic properties of the magnetic core can be easily adjusted by forming the gap portions in the magnetic core.

A method for producing a reactor according to an embodiment is a method for producing a reactor in which an assembly of a coil and a magnetic core is housed in a case, the coil having a pair of wound portions that are arranged side-by-side, and the magnetic core having inner core portions that are disposed inside the wound portions and outer core portions that are exposed from the wound portions, the method including: a case preparing step of preparing a case serving as the case that houses the coil and including a side wall portion having a cut-out portion that, when a direction in which the wound portions are arranged side-by-side is referred to as a side-by-side arrangement direction, exposes at least one of an external side surface of one of the wound portions in the side-by-side arrangement direction and an external side surface of the other of the wound portions in the side-by-side arrangement direction; a disposition step of housing the coil inside the case; and a filling step of filling a composite material containing a soft magnetic powder and a resin into spaces between end surfaces of the wound portions of the coil and the case, thereby forming the magnetic core composed of the composite material.

With this method for producing a reactor, the reactor of the embodiment can be produced simply by disposing a coil inside a case and filling a composite material into the case.

In the method for producing a reactor according to the embodiment, it is also possible that, in the disposition step, the coil is housed in the case in a state in which end surface connecting members abut against respective end surfaces of the coil, and edge portions of the cut-out portion of the case are sealed by the end surface connecting members.

Since the edge portions of the cut-out portion of the case are sealed by the end surface connecting members, leakage of the resin from the cut-out portion in the filling step can be suppressed without having to cover the cut-out portion with a mold or the like.

Hereinafter, embodiments of a reactor of the present disclosure will be described based on the drawings. In the drawings, like reference numerals denote objects having like names. It should be understood that the present disclosure is not to be limited to configurations described in the embodiments, but rather is to be defined by the appended claims, and all changes that come within the meaning and range of equivalency of the claims are intended to be embraced therein.

### Embodiment 1

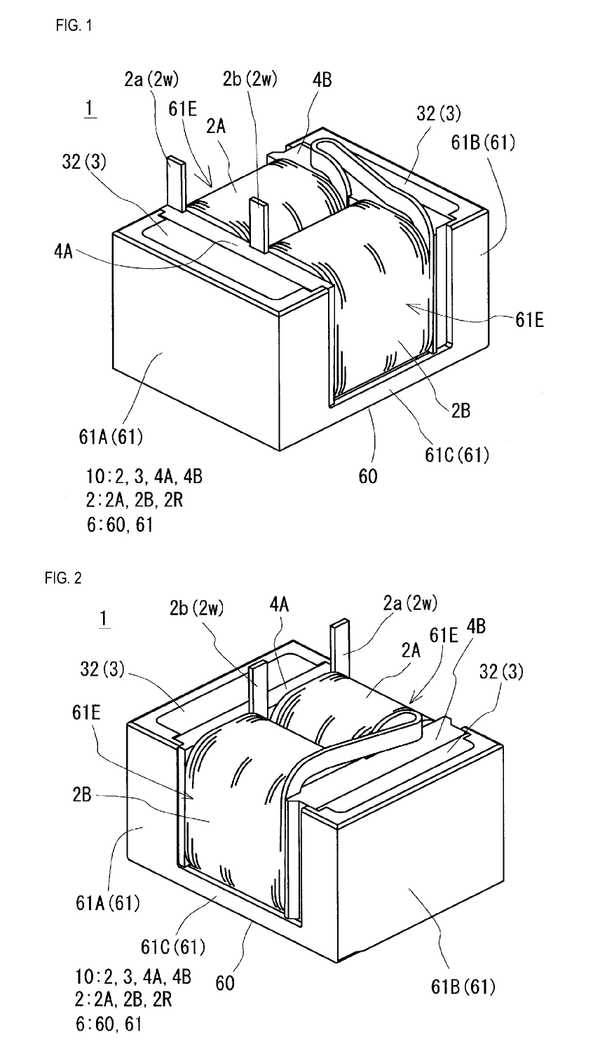

In Embodiment 1, the configuration of a reactor 1 will be described based on FIGS. 1 to 3. The reactor 1 shown in FIG. 1 includes an assembly 10 in which a coil 2, a magnetic core 3, and end surface connecting members 4A and 4B are combined, as well as a case 6 in which the assembly 10 is housed. A feature of this reactor 1 is the state in which the assembly 10 is housed in the case. Hereinafter, the various components of the reactor 1 will be described in detail, and then, a method for producing the reactor 1 will be described.

Assembly

Coil

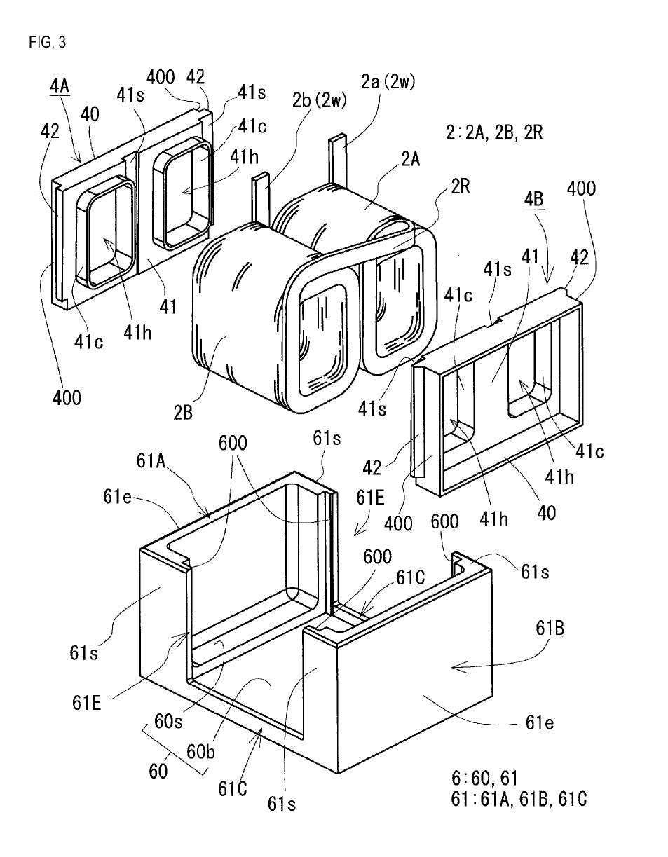

As shown in FIG. 3, the coil 2 of the present embodiment includes a pair of wound portions 2A and 2B and a connecting portion 2R that connects the two wound portions 2A and 2B to each other. The wound portions 2A and 2B are portions in which a wire 2w is helically wound, are formed into hollow tubular shapes having the same number of turns and the same winding direction, and are arranged side-by-side such that their axial directions are parallel to each other.

In the present example, the coil 2 is made from a single wire 2w; however, a coil 2 may also be made by connecting wound portions 2A and 2B that are made from separate wires to each other.

Each of the wound portions 2A and 2B of the present embodiment are formed into a rectangular tube shape. The wound portions 2A and 2B having a rectangular tube shape refer to wound portions whose end surfaces have a quadrangular shape (including a square shape) with rounded corners. It goes without saying that the wound portions 2A and 2B may also be formed into a cylindrical tube shape. A cylindrical tube-shaped wound portion refers to a wound portion whose end surfaces have a closed curved shape (elliptical shape, perfect circle shape, racetrack shape, or the like).

The coil 2 including the wound portions 2A and 2B can be formed of a coated wire including a conductor, such as a rectangular wire or a round wire, made of a conductive material, such as copper, aluminum, magnesium, or an alloy thereof, and an insulating coating made of an insulating material and provided on the outer periphery of the conductor. In the present embodiment, the wound portions 2A and 2B are formed by winding a coated rectangular wire edgewise, the coated rectangular wire being constituted by a rectangular wire (wire 26w) made of copper, which serves as a conductor, and an insulating coating made of an enamel (typically, polyamideimide).

Both end portions 2a and 2b of the coil 2 are drawn out from the wound portions 2A and 2B and are connected to respective terminal members, which are not shown. The insulating coating made of an enamel or the like is stripped from the end portions 2a and 2b. An external device such as a power supply that supplies power to the coil 2 is connected via the terminal members.

Preferably, the wound portions 2A and 2B of the coil 2 are integrated by using a resin. In the case of the present example, the wound portions 2A and 2B of the coil 2 are each individually integrated by using an integrating resin. The integrating resin of the present example is formed by fusion-bonding a coating layer that is formed on the outer periphery (outer periphery of the insulating coating made of an enamel or the like) of the wire 2w and that is made of a thermally fusion-bondable resin, and is extremely thin. Therefore, even when the turns of the wound portions 2A and 2B are integrated by using the integrating resin, the shapes of the turns, or the boundaries between the turns, of the wound portions 2A and 2B can be externally recognized. Thermosetting resins such as epoxy resins, silicone resins, and unsaturated polyester, for example, can also be used as the material of the integrating resin.

Magnetic Core

As shown in FIGS. 1 and 2, the magnetic core 3 can be divided into outer core portions 32 that are disposed outside the wound portions 2A and 2B and inner core portions that are disposed inside the wound portions 2A and 2B. In the present example, the outer core portions 32 and the inner core portions are integrally connected.

The magnetic core 3 is composed of a composite material containing a soft magnetic powder and a resin. The soft magnetic powder is an aggregate of magnetic particles composed of an iron-group metal such as iron, an alloy thereof (a Fe—Si alloy, a Fe—Ni alloy, etc.), or the like. As will be described later in the description of the method for producing a reactor, the magnetic core 3 is formed by filling the inside of the case 6 with the composite material after the coil 2 is housed in the case 6. Therefore, the outer core portions 32 of the magnetic core 3 are joined to the inner peripheral surface of the case 6.

End Surface Connecting Members

As shown in FIG. 3, the end surface connecting members 4A and 4B are members that ensure insulation between end surfaces of the wound portions 2A and 2B and the outer core portions 32 (see FIGS. 1 and 2). The end surface connecting members 4A and 4B can be composed of, for example, thermoplastic resins such as polyphenylene sulfide (PPS) resins, polytetrafluoroethylene (PTFE) resins, liquid crystal polymers (LCPs), polyamide (PA) resins such as nylon 6 and nylon 66, polybutylene terephthalate (PBT) resins, and acrylonitrile-butadiene-styrene (ABS) resins. In addition, the end surface connecting members 4A and 4B can be formed of thermosetting resins such as unsaturated polyester resins, epoxy resins, urethane resins, and silicone resins. It is also possible to improve the heat dissipation properties of the end surface connecting members 4A and 4B by mixing a ceramic filler into the above-described resins. For example, a non-magnetic powder such as alumina or silica can be used as the ceramic filler.

The end surface connecting member 4A, which is located on the side (wire end portion side) where the end portions 2a and 2b of the wound portions 2A and 2B are disposed, and the end surface connecting member 4B, which is located on the side (connecting portion side) where the connecting portion 2R is disposed, have components with the same functions. In FIG. 3, components with the same functions are denoted by like reference numerals even though these components slightly differ from each other in terms of size, shape, and the like.

The end surface connecting members 4A and 4B are each constituted by a rectangular frame portion 40 and an end surface contact portion 41, which is a B-shaped plate-like member that comes into contact with the end surfaces of the wound portions 2A and 2B. The rectangular frame portion 40 of the end surface connecting member 4B is longer than the rectangular frame portion 40 of the end surface connecting member 4A in the axial direction of the wound portions 2A and 2B. The rectangular frame portion 40 of the end surface connecting member 4B is set to be long in order to suppress leakage of the composite material from the positions of external side surfaces 400 (surfaces that oppose each other in the direction in which the wound portions 2A and 2B are arranged side-by-side) of the end surface connecting member 4B in the method for producing a reactor, which will be described later.

Two turn accommodating portions 41s (see, in particular, the end surface connecting member 4A) that accommodate axial end portions of the wound portions 2A and 2B are formed in a coil 2-side surface of each of the end surface contact portions 41. The turn accommodating portions 41s are recesses that conform to the shape of respective axial end surfaces of the wound portions 2A and 2B, and are formed in order to bring the entirety of end surfaces into surface contact with the end surface connecting members 4A and 4B. With the configuration in which the turn accommodating portions 41s bring the axial end surfaces of the wound portions 2A and 2B into surface contact with the end surface connecting members 4A and 4B, leakage of the resin from the contact portions can be suppressed.

The end surface contact portions 41 each include a pair of tubular portions 41c that respectively have through holes 41h. The tubular portions 41c are inserted into the inside of the wound portions 2A and 2B. The through holes 41h serve as inlets through which the composite material is filled into the inside of the wound portions 2A and 2B in the method for producing a reactor, which will be described later. Moreover, the tubular portions 41c inserted into the inside of the wound portions 2A and 2B have the functions of positioning the end surface connecting members 4A and 4B relative to the wound portions 2A and 2B and suppressing the leakage of the composite material that has been filled into the wound portions 2A and 2B from the end surfaces of the wound portions 2A and 2B.

The end surface connecting members 4A and 4B each include a pair of protruding portions 42 that protrude outward in the side-by-side arrangement direction, in which the wound portions 2A and 2B are arranged side-by-side, from positions near the wound portions 2A and 2B of the external side surfaces 400, which oppose each other in the side-by-side arrangement direction of the wound portions 2A and 2B. Here, the protruding portions 42 of the end surface connecting member 4A are formed with a uniform thickness toward their leading ends in the protruding directions, whereas the protruding portions 42 of the end surface connecting member 4B have tapered shapes that slope to the wire end portion side (upper left side on the paper plane) toward their leading ends in the protruding directions. The reason why the protruding portions 42 of the end surface connecting member 4B have such shapes will be explained later in the description of the method for producing a reactor.

Case

As shown in FIG. 3, the case 6 is constituted by a bottom plate portion 60 and a side wall portion 61. The bottom plate portion 60 and the side wall portion 61 may be formed integrally, or may be formed by preparing a bottom plate portion 60 and a side wall portion 61 separately and then connecting these portions to each other. For example, a non-magnetic metal, such as aluminum or an alloy thereof, magnesium or an alloy thereof, or the like, or a resin or the like can be used as the material of the case 6. In the case where the bottom plate portion 60 and the side wall portion 61 are formed separately, the two portions 60 and 61 can also be made of different materials. For example, it is conceivable that the bottom plate portion 60 is made of a non-magnetic metal and the side wall is made of a resin, or vice versa.

Bottom Plate Portion

The bottom plate portion 60 of the present example includes a coil mount portion 60b on which the wound portions 2A and 2B are mounted and core contact portions 60s that are located higher than the coil mount portion 60b and come into contact with bottom surfaces of the respective outer core portions 32 (FIGS. 1 and 2). The coil mount portion 60b is integrated with connecting portions 61C of the side wall portion 61, which will be described later, and the core contact portions 60s are integrated with respective core opposing portions 61A and 61B of the side wall portion 61, which will be described later.

Side Wall Portion

The side wall portion 61 of the present example is constituted by the pair of core opposing portions 61A and 61B that oppose the outer peripheral surfaces of the respective outer core portions 32 (FIGS. 1 and 2) and the connecting portions 61C that connect the core opposing portions 61A and 61B to each other. The connecting portions 61C are provided in order to improve the rigidity of the side wall portion 61 by connecting the core opposing portions 61A and 61B to each other, and have such a height that the connecting portions 61C cover only the lower bent corner portions of the wound portions 2A and 2B. Therefore, as shown in FIGS. 1 and 2, an external side surface of the wound portion 2A in the side-by-side arrangement direction and an external side surface of the wound portion 2B in the side-by-side arrangement direction are exposed to the outside of the case 6. In other words, the side wall portion 61 of the case 6 of the present example can also be said to have a shape having cut-out portions 61E that are formed by cutting out portions corresponding to the external side surfaces of the respective wound portions 2A and 2B that oppose each other in the side-by-side arrangement direction and expose those external side surfaces to the outside of the case 6.

As shown in FIG. 3, the core opposing portions 61A and 61B are formed into a substantially C-shape when viewed from above. Specifically, the core opposing portions 61A and 61B are each formed by an end surface cover portion 61e that covers an end surface (end surface on the opposite side to the coil 2) of the corresponding outer core portion 32 (FIGS. 1 and 2) and a pair of side cover portions 61s that cover respective side surfaces of the outer core portion 32 being connected together into a C-shape. The outer surfaces of the side cover portions 61s are substantially flush with the external side surfaces of the respective wound portions 2A and 2B. The side cover portions 61s each include a thin portion 600 that is formed by reducing the thickness thereof near a corresponding coil 2-side edge portion, and as shown in FIGS. 1 and 2, the thin portions 600 cover the corresponding external side surfaces 400 of the end surface connecting members 4A and 4B. When the overlapping length between the thin portions 600 and the external side surfaces 400 is increased, leakage of the composite material from gaps between the end surface connecting members 4A and 4B and the core opposing portions 61A and 61B of the side wall portion 61 in the method for producing a reactor, which will be described later, can be suppressed.

Effects of Reactor

In the reactor 1 of the present example, the outer core portions 32 of the magnetic core 3 can be physically protected by the core opposing portions 61A and 61B of the side wall portion 61 of the case 6. Moreover, since the external side surfaces of the wound portions 2A and 2B are exposed from the side wall portion 61 of the case 6, heat is more likely to dissipate from the coil 2 to the outside of the case 6, and the heat dissipation properties of the reactor 1 can be further improved.

Uses

The reactor 1 of the present example can be used as a constituent member of a power conversion device such as a bidirectional DC-DC converter installed in electric vehicles such as hybrid automobiles, electric automobiles, and fuel-cell electric automobiles.

The reactor 1 can be used in a state in which it is immersed in a liquid coolant. Although there is no limitation on the liquid coolant, if the reactor 1 is used in a hybrid automobile, ATF (Automatic Transmission Fluid) or the like can be used as the liquid coolant. In addition, fluorine-based inert liquids such as Fluorinert (registered trademark), fluorocarbon-based coolants such as HCFC-123 and HFC-134a, alcohol-based coolants such as methanol and alcohol, and ketone-based coolants such as acetone can also be used as the liquid coolant.

Method for Producing Reactor

Next, an example of a method for producing a reactor that is used to produce the reactor 1 according to Embodiment 1 will be described. Roughly speaking, the method for producing a reactor includes the following steps. The method for producing a reactor will be described with reference mainly to FIG. 3.
Coil producing step
Integrating step
Case preparing step
Disposition step
Filling step
Curing step

Coil Producing Step

In this step, the wire 2w is prepared, and portions of the wire 2w are wound to produce the coil 2. A known winding machine can be used to wind the wire 2w. A coating layer that is composed of a thermally fusion-bondable resin and that constitutes the integrating resin, which integrates the turns of the wound portions 2A and 2B, can be formed on the outer periphery of the wire 2w. The thickness of the coating layer can be selected as appropriate. If the integrating resin is not provided, a wire 2w without a coating layer can be used, and the next integrating step is not required.

Integrating Step

In this step, the wound portions 2A and 2B of the coil 2 that has been produced in the coil producing step are integrated using the integrating resin. In the case where a coating layer composed of a thermally fusion-bondable resin is formed on the outer periphery of the wire 2w, the integrating resin can be formed by heat-treating the coil 2. On the other hand, in the case where no coating layer is formed on the outer periphery of the wire 2w, the integrating resin can be formed by applying a resin to the outer periphery or the inner periphery of the wound portions 2A and 2B of the coil 2 and curing the resin.

Case Preparing Step

In this step, as shown in FIG. 3, the case 6 including the side wall portion 61 having the cut-out portions 61E that expose the external side surface of one wound portion 2A in the side-by-side arrangement direction and the external side surface of the other wound portion 2B in the side-by-side direction is prepared as the case 6 for housing the coil 2. Note that the case preparing step can also be performed prior to the coil producing step or the integrating step.

Disposition Step

In this step, the coil 2 is disposed inside the case 6. In the present example, a first assembly in which the end surface connecting members 4A and 4B are attached to the coil 2 is inserted into the case 6 from above the case 6. The external side surfaces 400 of the end surface connecting members 4A and 4B are covered by the thin portions 600 of the core opposing portions 61A and 61B (see both of FIGS. 1 and 2). A space is formed between the inner peripheral surface of each core opposing portion 61A (61B) and the corresponding end surface connecting member 4A (4B). Also, the external side surface of the wound portion 2A is exposed from one of the cut-out portions 61E, and the external side surface of the wound portion 2B is exposed from the other cut-out portion 61E. Here, a heat dissipation material, which is not shown, may also be disposed between the coil mount portion 60b and the first assembly. For example, heat dissipation grease, a foamed heat dissipation sheet, or the like can be used as the heat dissipation material.

Filling Step

In the filling step, the composite material is filled into the space that is formed between the inner peripheral surface of each core opposing portion 61A (61B) and the corresponding end surface connecting member 4A (4B) from above that space. The composite material that has been filled into the case 6 accumulates in the space between each core opposing portion 61A (61B) and the corresponding end surface connecting member 4A (4B) and also flows into the inside of the wound portions 2A and 2B via the through holes 41h of the end surface connecting members 4A and 4B. Since the thin portions 600 of the core opposing portion 61A (61B) cover the respective external side surfaces 400 of the end surface connecting member 4A (4B), leakage of the composite material to the outside of the case 6 from the positions of the external side surfaces 400 of the end surface connecting member 4A (4B) is suppressed.

When filling the composite material, jigs are inserted between the tapered surfaces of the protruding portions 42 of the end surface connecting member 4B and edge portions of the corresponding side cover portions 61s of the core opposing portion 61B of the case 6, and the end surface connecting member 4B is pressed toward the wire end portion. Here, since the rectangular frame portion 40 of the end surface connecting member 4B is formed to be long, even when the end surface connecting member 4B is pressed toward the wire end portion, a sufficient overlapping length between the external side surfaces 400 and the thin portions 600 is secured. Pressing the end surface connecting member 4B toward the wire end portion makes it possible to suppress movement of the coil 2 within the case 6 due to filling pressure of the composite material and suppress leakage of the composite material from the case 6. Moreover, pressing the end surface connecting member 4B toward the wire end portion enables the end portions 2a and 2b of the coil 2 to be accurately positioned relative to the case 6, and thus, when the reactor 1 is disposed at a predetermined position in a vehicle, the reactor 1 can be easily connected to other members.

Curing Step

In the curing step, the composite material is cured through heat treatment or the like. The portions of the cured composite material that are present inside the wound portions 2A and 2B constitute the inner core portions, and the portions of the cured composite material that are present outside the wound portions 2A and 2B constitute the outer core portions 32.

### Embodiment 2

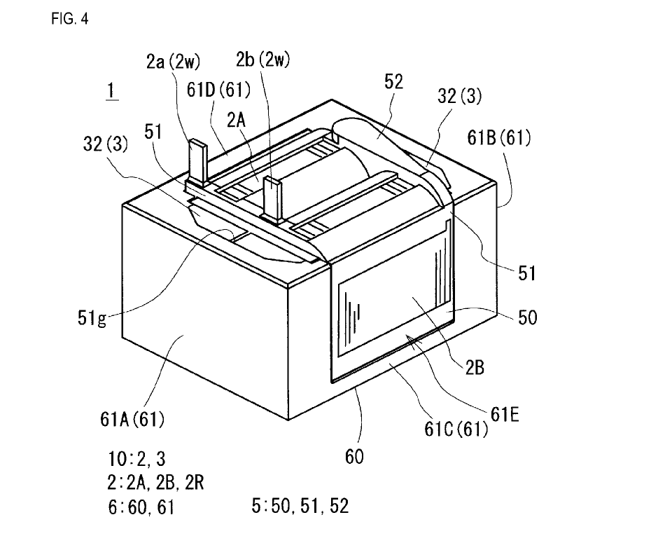

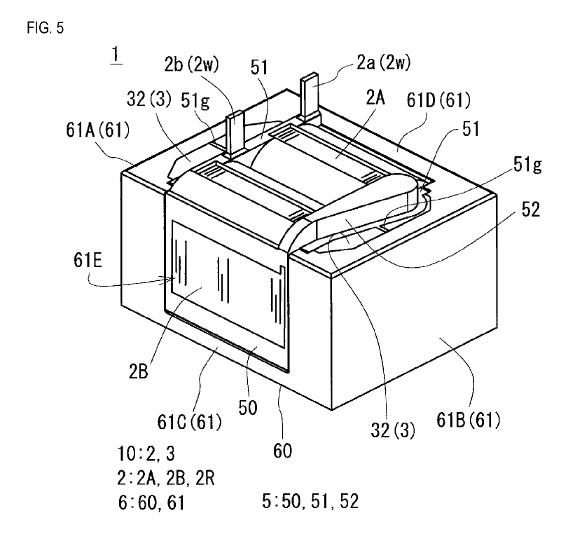

In Embodiment 2, a reactor 1 in which only one of the wound portions is exposed from the case 6 will be described based on FIGS. 4 to 6. Components having the same functions as those of Embodiment 1 are denoted by like reference numerals as those of Embodiment 1, and their description is omitted.

Case

The case 6 of Embodiment 2 differs from the case 6 of Embodiment 1 in terms of the configuration of the side wall portion 61. The side wall portion 61 of the case 6 of the present example includes a coil opposing portion 61D, in addition to the core opposing portions 61A and 61B and the connecting portion 61C on the wound portion 2B side. The coil opposing portion 61D is a member that opposes the external side surface of the wound portion 2A. That is to say, the side wall portion 61 of the case 6 of the present example is configured so as to enclose three surfaces of the outer peripheral surface of the assembly 10, excluding the external side surface of the wound portion 2B. The external side surface of the wound portion 2B is exposed to the outside of the case 6 at the position of the cut-out portion 61E. It goes without saying that the coil opposing portion 61D may also be provided on the wound portion 2B side so that the external side surface of the wound portion 2A is exposed to the outside of the case 6.

Coil

The reactor 1 of the present example also differs from that of Embodiment 1 in that the coil 2 is provided with a coil molded portion 5 instead of end surface connecting members. The coil molded portion 5 is composed of an insulating resin, and for example, the same materials as those of the end surface connecting members of Embodiment 1 can be used. As is the case with the end surface connecting members, the coil molded portion 5 may also contain a filler.

The coil molded portion 5 includes turn coating portions 50 that integrate the turns of the individual wound portions 2A and 2B and end surface coating portions 51 that are disposed between the end surfaces of the wound portions 2A and 2B and the outer core portions 32. Furthermore, the coil molded portion 5 includes a connecting-portion coating portion 52 that covers the connecting portion (not shown) between the wound portions 2A and 2B.

The wound portions 2A and 2B, which have a rectangular tube shape, of the coil 2 are each divided into four-corner portions that are formed by the wire 2w being bent and flat portions where the wire 2w is not bent. The turn coating portions 50 of the present example integrate the turns of the corresponding wound portions 2A and 2B by covering the four-corner portions of the wound portions 2A and 2B. The turn coating portions 50 do not cover the flat portions of the wound portions 2A and 2B, and therefore, heat dissipation from external side surfaces of the wound portions 2A and 2B is not inhibited by the turn coating portions 50.

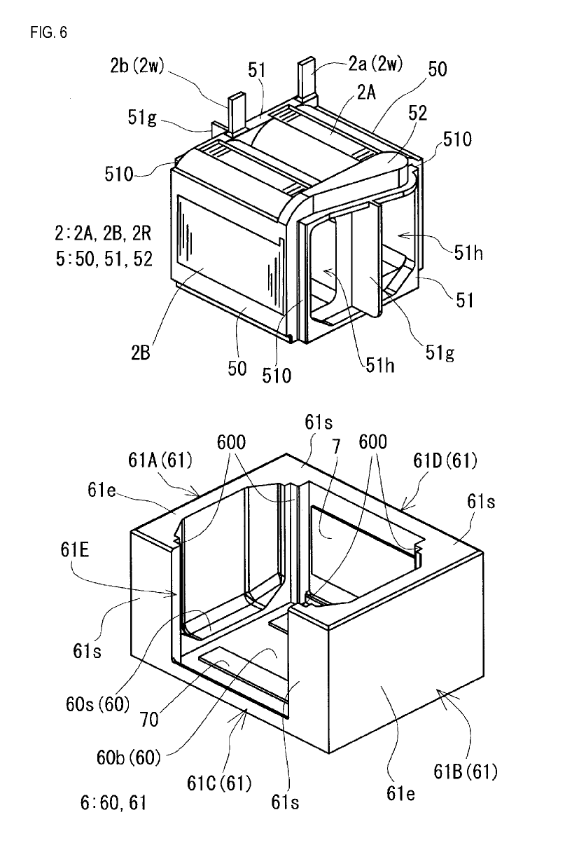

As shown in FIG. 6, the end surface coating portions 51 are provided so as to connect the turn coating portions 50 of the wound portion 2A and the turn coating portions 50 of the wound portion 2B. In each of the end surface coating portions 51, a pair of through holes 51h that are in communication with the inside of the wound portions 2A and 2B, respectively, are formed. The through holes 51h have the same function as the through holes 41h of the end surface connecting members 4A and 4B of Embodiment 1, that is, the function of guiding the composite material into the inside of the wound portions 2A and 2B during the production of the reactor.

The end surface coating portions 51 are each formed into a frame-like shape that protrudes away from the coil 2 in the axial direction of the wound portions 2A and 2B. External side surfaces (surfaces that oppose each other in the side-by-side arrangement direction of the wound portions 2A and 2B) 510 of the frame-shaped end surface coating portions 51 abut against the thin portions 600 of the core opposing portions 61A and 61B of the case 6. The external side surfaces 510 have the same functions as the external side surfaces 400 of the end surface connecting members 4A and 4B of Embodiment 1, that is, the functions of positioning the coil 2 in the case 6 and suppressing leakage of the composite material during the production of the reactor 1.

Each end surface coating portion 51 further includes a gap portion 51g that is provided between the pair of through holes 51h. The gap portion 51g is a plate-like member that protrudes away from the coil 2 in the axial direction of the wound portions 2A and 2B. As shown in FIGS. 4 and 5, the gap portion 51g divides the outer core portion 32 in the side-by-side arrangement direction of the wound portions 2A and 2B and forms a gap at a position of the outer core portion 32. Magnetic properties of the magnetic core 3 can be adjusted by adjusting the thickness of the gap portion 51g. Here, the gap portion 51g is not limited to a gap portion that physically completely divides the outer core portion 32 into two parts, and it is sufficient that the gap portion 51g is configured to be able to divide the magnetic circuit of the outer core portion 32. That is to say, the gap portion 51g need not be provided in a portion where it will not affect the magnetic circuit of the outer core portion 32. For example, even if a gap portion 51g has such a length that it does not reach the end surface of the outer core portion 32 in the axial direction of the wound portions 2A and 2B, it is sufficient that the gap portion 51g is disposed in a portion that constitutes the magnetic circuit.

Effects of Reactor

The configuration of Embodiment 2 can increase the flexibility of installation of the reactor 1 more than the configuration in which both side surfaces of the coil 2 are exposed, while improving the heat dissipation properties of the reactor 1. The reason for this is that, with the configuration in which the side wall portion 61 of the case 6 includes the coil opposing portion 61D, not only the bottom plate portion 60 and the core opposing portions 61A and 61B but also the coil opposing portion 61D can be used as an attachment portion that can be attached to an object in which the reactor 1 is installed.

Method for Producing Reactor

To produce the reactor 1 according to Embodiment 2, as shown in FIG. 6, the coil 2 with the coil molded portion 5 and the case 6 are prepared. Then, the coil 2 is inserted into the inside of the case 6 (disposition step). At this time, it is advantageous to dispose a heat dissipation material 7 on the inner peripheral surface of the coil opposing portion 61D and also dispose a heat dissipation material 70 on the coil mount portion 60b. The dissipation of heat from the coil 2 to the case 6 can be promoted by providing the heat dissipation materials 7 and 70. For example, heat dissipation grease, a foamed heat dissipation sheet, or the like can be used as the heat dissipation materials 7 and 70.

As a result of inserting the coil 2 into the case 6, a space is formed between the inner peripheral surface of each core opposing portion 61A (61B) and the corresponding end surface coating portion 51. The composite material is filled into this space from above the space (filling step). The composite material that has been filled into the case 6 from this space accumulates in the space between each core opposing portion 61A (61B) and the corresponding end surface coating portion 51, thereby forming each outer core portion 32 (FIGS. 4 and 5), and flows into the inside of the wound portions 2A and 2B via the through holes 51h, thereby forming the inner core portions. Here, since the thin portions 600 of each core opposing portion 61A (61B) cover the external side surfaces 510 of the end surface coating portion 51, leakage of the composite material to the outside of the case 6 from the positions of the external side surfaces 510 of the end surface coating portion 51 is suppressed.

### Embodiment 3

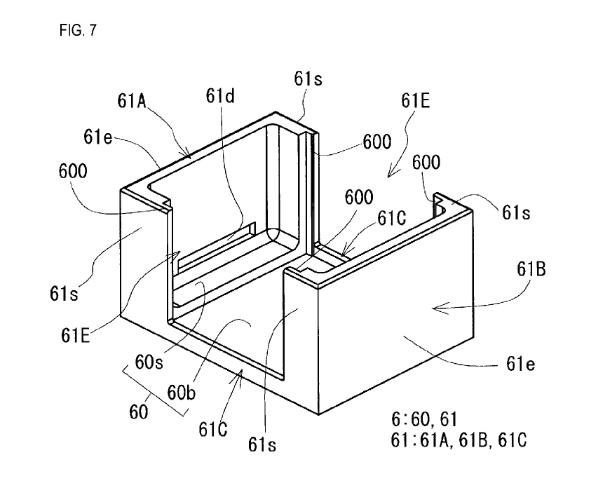

As described in Embodiments 1 and 2, the magnetic core 3 of the present disclosure is configured by filling the composite material into the case 6. That is to say, the outer core portions 32 of the magnetic core 3 are joined to the inner peripheral surface of the side wall portion 61 (inner peripheral surfaces of the core opposing portions 61A and 61B), and detachment of the assembly 10 from the case 6 is thus suppressed. In order to more effectively suppress detachment of the assembly 10 from the case 6, it is preferable to provide the case 6 with a detachment preventing configuration. A specific example of the detachment preventing configuration will be described based on FIG. 7.

FIG. 7 is a schematic perspective view of a case 6 for use in Embodiment 3. The case 6 in FIG. 7 is almost the same as the case 6 in FIG. 3 of Embodiment 1, but differs from the case 6 of Embodiment 1 in that the inner peripheral surface of the core opposing portion 61A has a detachment preventing recess 61d. Note that, although located at a position that cannot be seen in FIG. 7, the inner peripheral surface of the core opposing portion 61B also has a detachment preventing recess 61d that is similar to that of the core opposing portion 61A.

The detachment preventing recess 61d is formed by a portion near the bottom plate portion 60, of the inner peripheral surface of the end surface cover portion 61e of the core opposing portion 61A being recessed in a direction away from the outer core portion 32 (see FIG. 1). If the composite material is filled into the inside of the case 6 that has this detachment preventing recess 61d, a portion of the outer core portion 32 enters the detachment preventing recess 61d, and the outer core portion 32 engages with the detachment preventing recess 61d. This engagement can suppress detachment of the assembly 10 from the case 6.

Unlike FIG. 7, the detachment preventing recess 61d can also be provided at a position of a side cover portion 61s. Moreover, the detachment preventing recess 61d can also be applied to the case 6 of Embodiment 2.

1. A reactor comprising:
a coil having a pair of wound portions that are arranged side-by-side;
a magnetic core having inner core portions that are disposed inside the wound portions and outer core portions that are exposed from the wound portions; and
a case that houses an assembly of the coil and the magnetic core,
wherein the case includes a bottom plate portion on which the assembly is mounted and a side wall portion having portions that oppose outer peripheral surfaces of the outer core portions,
the magnetic core is composed of a composite material containing a soft magnetic powder and a resin, and is joined to an upper surface of the bottom plate portion and an inner peripheral surface of the side wall portion, at positions of the outer core portions, and
when a direction in which the wound portions are arranged side-by-side is referred to as a side-by-side arrangement direction, the side wall portion includes a cut-out portion that exposes at least one of an external side surface of one of the wound portions in the side-by-side arrangement direction and an external side surface of the other of the wound portions in the side-by-side arrangement direction to the outside of the case.

2. The reactor according to claim 1,
wherein the side wall portion includes:
a pair of core opposing portions that oppose the outer peripheral surfaces of the outer core portions;
one of said cut-out portions that exposes the external side surface of one of the wound portions to the outside of the case; and
another one of said cut-out portions that exposes the external side surface of the other of the wound portions to the outside of the case.

3. The reactor according to claim 1,
wherein the side wall portion includes:
a pair of core opposing portions that oppose the outer peripheral surfaces of the outer core portions;
a coil opposing portion that connects the pair of core opposing portions to each other and opposes the external side surface of one of the wound portions or the external side surface of the other of the wound portions; and
the cut-out portion that exposes the external side surface of the wound portion on the opposite side to the wound portion that is covered by the coil opposing portion to the outside of the case, and
the reactor further comprising
a heat dissipation material that is disposed between the coil opposing portion and the wound portion.

4. The reactor according to claim 1, further comprising
a pair of end surface connecting members that are disposed between end surfaces of the wound portions and the outer core portions,
wherein the inner peripheral surface of the side wall portion abuts against at least a portion of external side surfaces of the end surface connecting members that oppose each other in the side-by-side arrangement direction.

5. The reactor according to claim 4,
wherein each of the end surface connecting members includes protruding portions that protrude outward in the side-by-side arrangement direction, the protruding portions being located at positions near the wound portions of the external side surfaces of the end surface connecting members that oppose each other in the side-by-side arrangement direction of the wound portions, and
when a side on which end portions of a wire that forms the wound portions are disposed is referred to as a wire end portion side, and a side on which a connecting portion of the wire that connects the pair of wound portions to each other is disposed is referred to as a connecting portion side, the protruding portions of the end surface connecting member on the connecting portion side have a tapered shape that slopes to the wire end portion side toward leading ends of the protruding portions in the protruding directions.

6. The reactor according to claim 1,
wherein the coil includes a coil molded portion composed of an insulating resin, and
the coil molded portion includes:
turn coating portions that integrate the turns of the wound portions; and
end surface coating portions that are disposed between the end surfaces of the wound portions and the outer core portions.

7. The reactor according to claim 1,
wherein the side wall portion includes a pair of core opposing portions that oppose outer peripheral surfaces of the outer core portions,
each of the core opposing portions includes a detachment preventing recess that is formed by a portion near the bottom plate portion of an inner peripheral surface of the core opposing portion being recessed in a direction away from a corresponding one of the outer core portions, and
a portion of the outer core portion enters the detachment preventing recess.

8. The reactor according to claim 1, further comprising
gap portions in the outer core portions.

9. A method for producing a reactor in which an assembly of a coil and a magnetic core is housed in a case, the coil having a pair of wound portions that are arranged side-by-side, and the magnetic core having inner core portions that are disposed inside the wound portions and outer core portions that are exposed from the wound portions, the method comprising:
a case preparing step of preparing a case serving as the case that houses the coil and including a side wall portion having a cut-out portion that, when a direction in which the wound portions are arranged side-by-side is referred to as a side-by-side arrangement direction, exposes at least one of an external side surface of one of the wound portions in the side-by-side arrangement direction and an external side surface of the other of the wound portions in the side-by-side arrangement direction;
a disposition step of housing the coil inside the case; and
a filling step of filling a composite material containing a soft magnetic powder and a resin into spaces between end surfaces of the wound portions of the coil and the case, thereby forming the magnetic core composed of the composite material.

10. The method for producing a reactor according to claim 9,
wherein, in the disposition step, the coil is housed in the case in a state in which end surface connecting members abut against respective end surfaces of the coil, and edge portions of the cut-out portion of the case are sealed by the end surface connecting members.
